(19) United States
(12) Patent Application Publication
(10) Pub. No.: US 2005/0078655 A1
(43) Pub. Date: Apr. 14, 2005

(54) Hierarchical credit queuing for traffic shaping

(75) Inventors: Emil Tiller, Adelaide (AU); Chec Kent Lan, Adelaide (AU); Peter Levibe, Adelaide (AU)

Correspondence Address: AKERMAN SENTERFITT, P.O. BOX 3188, WEST PALM BEACH, FL, 33402-3188, US

(73) Assignee: Foursticks Pty. Ltd., Frewville, South Australia, (AU)

(21) Appl. No.: 10/497,045

(22) PCT Filed: Nov. 29, 2002
(86) PCT No.: PCT/AU02/01616

(30) Foreign Application Priority Data
Nov. 30, 2001 (AU) PR 9180

(51) Int. Cl. H04L 12/28

(52) U.S. Cl. 370/351

(57) ABSTRACT

A method in a packet switching system for arbitrating access for incoming channels (100÷109) to an outgoing channel (120) so that each channel is constrained within a minimum bandwidth, a maximum bandwidth, and a defined inter-packed delay range by use of a transferable credit value system, including a channel value for each channel, a master value, and selecting one incoming channel (100) to be permitted to transmit a packet through the outgoing channel (120), upon a transmission from one of the incoming channels (100÷109) to the outgoing channel (120) being permitted, changing the credit for that channel and making a corresponding change in the master value. Channels are eligible to transmit packets while they have a channel value within a specified limit. Channel values are reset when the master value falls outside a specified limit.

### TECHNICAL FIELD

This invention relates to packet switching.

### BACKGROUND ART

The following is a description of some previous proposed systems which have been considered this reference to these however not being intended to be any admission that these systems are currently published or have been previously used or are common general knowledge. The problem is to try to ensure minimum and maximum bandwidths are achieved as well as real time delay bound constraints in a traffic shaping system. One of these as a mechanism is a weighted fair queuing (WFQ) system. Weighted fair queuing attempts to separate out flows into different categories and give each category a ratio of the link if they need it. This means that packets are guaranteed a minimum bandwidth based on this ratio. It also allows a delay bound to be calculated between successive packets for a flow. A problem arises that in order to get an improved delay bound, the effective ratio given to the queue in question must be raised. Hence delay bound is tightly coupled to effective minimum bandwidth. Often applications have small minimum bandwidth characteristics but have tight delay bound characteristics. This is not solved by weighted fair queuing.

To cap a maximum rate at which a flow can leave the system, a Token Bucket Filtering (TBF) can be used. This mechanism can be explained as conceptual tokens being placed in a bucket at a set rate up to some maximum rate. When a flow wants to send a packet, it must first get the required number of tokens from the bucket. If it can't get the tokens, it must wait until the bucket has enough tokens in it. This means that flows can get their minimum guaranteed rate. If the bucket fills up, they can also burst, transmitting data at a speed greater than the instantaneous capacity of the system. This burst can be considered undesirable in some circumstances.

### DISCLOSURE OF THE INVENTION

It is an object of this invention to provide the public with a useful alternative.

It is a further object of this invention to reduce potential for channel burst to occur.

In one form of the invention, this can be said to reside in a packet switching arrangement including at least two incoming channels and one outgoing channel wherein there is a first means for storing a credit value for each incoming channel, second means for storing a master value, third means adapted to effect a selection of one incoming channel to be permitted to transmit a packet through the outgoing channel, fourth means adapted to effect, upon a transmission from one of the incoming channels to the outgoing channel being permitted, a change in the credit value for that channel and a corresponding change in the master value.

In preference the change in each of the values shall be equal.

In preference each incoming channel has allocated to it a first selected value limit and said third means is further characterised in that it is adapted such that it will not select a given incoming channel while that channel has a value varying from its initial state by more than the magnitude of said first value limit for said channel and while there is at least one other incoming channel with a value varying from its initial state by less than the magnitude of said other channel's first value limit, and where said other channel also has at least one packet to transmit.

In preference the master value has allocated to it a second selected value limit, said fourth means is further characterised in that it is adapted such that when the master value has a value varying from its initial state by more than the magnitude of said second value limit, each channel value and the master value are reset to their initial value.

In preference when each channel value is reset, any magnitude of the channel value immediately prior to the reset, greater than the first value limit for that channel, is offset against the initial value for the channel value for that channel.

In preference when the master value is reset, any magnitude of the master value immediately prior to the reset, greater than the second value limit, is distributed to enhance the channel value of such channels as did not vary the channel value from its initial state by more than the first value limit for that channel.

In preference there are means to characterise an incoming channel as having a selected transmission requirement and said third means is further characterised in that said transmission requirements are satisfied.

In preference the transmission requirement is a maximum inter-packet delay.

In preference, in the alternative, the transmission requirement is a fixed inter-packet delay.

In preference the transmission requirement is a minimum bandwidth.

In preference the transmission requirement is a maximum bandwidth.

In preference the value kept for each channel and the master value are such that each channel is constrained within a minimum bandwidth, a maximum bandwidth, and a defined inter-packet delay range.

In preference the third means includes further means to allocate to each incoming channel a state identifier, such identifier being initially selected based on the transmission requirements for that channel and being varied according to the subsequent behaviour of the channel.

In preference the state identifier may take a value to indicate that a channel has inter-packet delay requirements.

In preference the state identifier may take a value to indicate that a channel has minimum bandwidth requirements.

In preference the state identifier may take a value to indicate that a channel has exceeded its minimum transmission requirements.

In preference the state identifier may take a value to indicate that a channel has exceeded its maximum bandwidth restriction.

In preference the state identifier may take a value to indicate that a channel has no packets to send.

In preference the third means is further characterised in that the selection of a channel is based on the state identifier and further means is provided to update the state identifier of the selected channel if the transmission of the packet makes the channel eligible for a different value of the state identifier.

In preference there are means to store a second channel value for each channel and incoming channels are given access to bandwidth on the outgoing channel which is greater that that required to meet the transmission requirement of all of the channels in proportion to the value of the second channel value offset by the value of the first channel value.

The invention may also be said to reside in a method for arbitrating access for at least two incoming channels to one outgoing channel such that each channel is constrained within a minimum bandwidth, a maximum bandwidth, and a defined inter-packet delay range, including the steps of storing a channel value for each channel, storing a master value, selecting one incoming channel to be permitted to transmit a packet through the outgoing channel, upon a transmission from one of the incoming channels to the outgoing channel being permitted, changing the credit value for that channel and making a corresponding change in the master value.

In preference the method includes the further steps of allocating to each incoming channel a first selected value limit and not selecting a given incoming channel to be permitted to transmit a packet through the outgoing channel while that channel has a channel value varying from its initial state by more than the magnitude of said first value limit for said channel while there is at least one other incoming channel with a value varying from its initial state by less than the magnitude of said other channel's first value limit, where said other channel also has at least one packet to transmit.

In preference the method includes the further steps of allocating a second selected value limit, when the master value has a value varying from its initial state by more than the magnitude of said second value limit, resetting each channel value and the master value are to their initial value, offsetting any magnitude of the channel value immediately prior to the reset, greater than the first value limit for that channel, against the initial value for the channel value for that channel, distributing any magnitude of the master value immediately prior to the reset, greater than the second value limit, to enhance the channel value of such channels as did not vary the channel value from its initial state by more than the first value limit for that channel.

### BRIEF DESCRIPTION OF THE DRAWINGS

FIG. 1 shows the system architecture of the invention.

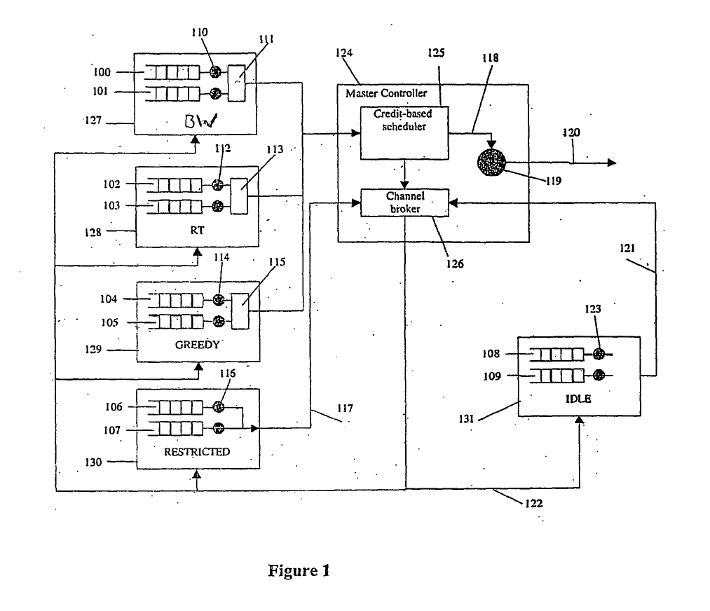

FIG. 2 shows a state diagram of the system. It shows how channels flow through the system.

### BEST METHOD OF PERFORMANCE

For a better understanding of the invention it will now be described with relation to a preferred embodiment where, however, it will be understood the specific embodiment illustrates only one form of the invention.

Channels 100, 101, 102, 103, 104, 105, 106, 107, 108 and 109 are logical flows A channel is a logical flow of packets for a particular traffic stream. All packets going through a channel have the same mark after going through a packet marker. Each channel in the system has a packet queue associated with it (eg. see 100). Incoming packets that are marked with the channel enter the associated packet queue for further processing. This is the first entry point of any packet into the system.

The system will allocate a certain amount of credits to each channel based on their BW. Using the state of the channel and the amount of credits used, the system will select and schedule a channel to release a packet for transmission. Once the channel has been allowed to send its packet, the system will update the channel state and credits. The whole process repeats itself again until each channel has no more packets left to send.

There are two types of credits that are used by the system:
MASTER Credits—are used to keep track of overall traffic and are consumed when packets are sent out from any channel. The master controller of the system owns the Master Credits. The master credit limit is equal to the sum of the Channel Credits.
CHANNEL Credits—are used to keep track of traffic for a particular channel. Each channel owns its own Channel Credits.

The Master credit system keeps track of the overall credit utilization and decides when to return the channel credits used by channels. Every packet that a channel transmits will consume channel credits. For simplicity, 1credit=1 byte. So if the system extracts a packet of 1500 bytes from the channel, the channel will consume 1500 channel credits. Subsequently when the packet is actually sent by the system, 1500 master credits will be consumed.

Packets are buffered in the channel awaiting transmission by the system.

Rate limiters 110, 112, 114, 116 and 119 limit the rate at which packets flow from the previous element into the next element. If the act of sending a packet to its next location in the system would result in the rate of transmission being higher than the set limit, the packet shall not be sent.

A channel can have one of the following states:
NONE (201)—not assigned by a user.
IDLE (202)—has been assigned for use but no packets for that channel have been received.
RT (realtime) (204)—this channel has been assigned and has a real-time guarantee placed on it. It also currently has packets to send.
BW (203)—this channel has been assigned and there is no real-time constraint placed on it. It also currently has packets to send.
GREEDY (205)—this channel has been assigned but it has exceeded its RT/BW credit level. It currently has more packets to send.
RESTRICTED (206)—this channel has exceeded the maximum throughput of the channel rate limiter. It also has more packets to send.

The BW subsystem 127 includes the BW channel scheduler 111 which is responsible for selecting the next packet from the BW subsystem to be sent. Channels enter the BW subsystem from the channel broker 126 when they have sufficient credit (are below their minimum bandwidth) and are not classified as realtime channels.

The RT channel scheduler 113 is responsible for selecting the next packet from the RT subsystem 128 to be sent. Channels enter the RT subsystem from the channel broker 126 when they have sufficient credit (are below their minimum bandwidth) and are classified as realtime channels.

The GREEDY channel scheduler 115 is responsible for selecting the next packet from the GREEDY subsystem 129 to be sent. Channels enter the GREEDY subsystem from the channel broker 126 when they have exceeded their BW credit limit (are above their minimum bandwidth). They can be either realtime of non-realtime channels.

Channels enter the RESTRICTED subsystem 130 from the channel broker 126 when they have exceeded their maximum bandwidth. They shall wait the required number of quanta before they build up enough credit to re-enter the system 117. When this occurs, they are moved to the channel broker 126 and redistributed to the system.

Channels enter the IDLE subsystem 131 from the channel broker 126 when the have no packets to send 122. When they have packets to send again, they move back to the channel broker 121 for redistribution in the system.

The Credit Based Scheduler 125 is responsible for choosing the next packet to leave the system and redistributing channels to the channel broker for updates. It always asks the RT subsystem for a packet first. If the RT subsystem has no packets to send, it shall ask the BW subsystem. If the RT and BW subsystems don't have packets to send, it shall ask the GREEDY subsystem for a packet to send. Packets then pass through the outgoing rate limiter 119 through to the interface card 120. All these are incorporated in the Master Controller 124.

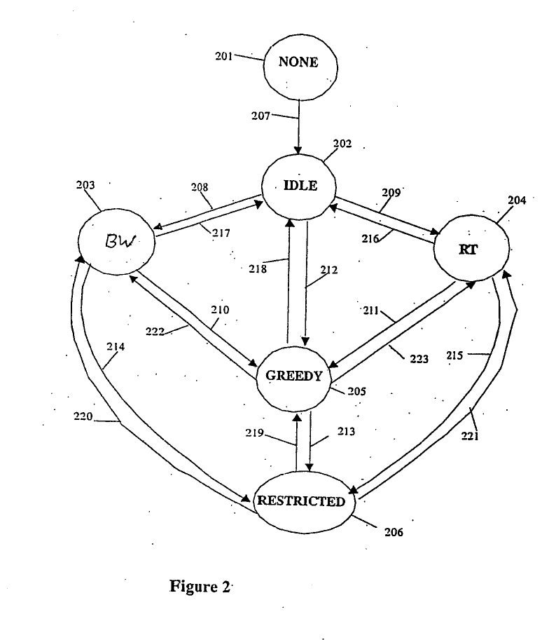

The operation of the system can be illustrated by a state diagram as in FIG. 2.

201 refers to the NONE state. In this state, a channel has not yet been properly assigned to the system. 202 refers to the IDLE state. Channels in the IDLE state are inside the IDLE subsystem 131. 203 refers to the BW state. Channels in the BW state are inside the BW subsystem 127. 204 refers to the RT state. Channels in the RT state are inside the RT subsystem 128. 205 refers to the GREEDY state. Channels in the GREEDY state are inside the GREEDY subsystem 129. 206 refers to the RESTRICTED state. Channels in the RESTRICTED state are inside the RESTRICTED subsystem 130.

Once a channel is assigned, it is moved into the IDLE state 207. In the IDLE state, channels have no packets to send. Once a channel has a packet to send, it will be moved to either the:
BW state 208 if the channel is considered a non realtime channel and it is under its credit limit (under the minimum bandwidth)
RT state 209 if the channel is considered a realtime channel and it is under its credit limit (under the minimum bandwidth)
GREEDY state 212 if the channel has exceeded its credit limit (over the minimum bandwidth)

From any of the states BW, RT and GREEDY, the channel can be moved to the RESTRICTED state (214, 215 and 213 respectively). This means that a channel has exceeded its maximum bandwidth and must wait a period of time before it can move back to a relevant state ready to transmit (220, 221 or 219).

If a channel no longer has a packet to transmit in the GREEDY, BW or RT state, it will move back to the IDLE state (218, 217 and 216 respectively).

Once the master credits in the system have been used for a particular round, channels in the GREEDY state can be moved back to BW 222 or RT 223. When this happens, channel credits are returned to all channels, regardless of what state they are in.

Each channel has a credit utilisation counter to keep track of channel credits used. Each channel also has 2 configurable credit limits. The first limit is the RT/BW limit and the next limit is the GREEDY limit. The GREEDY limit is always equal to or more than the RT/BW limit. Once credit utilisation crosses these limits, it signals the master controller 124 of a possible channel state change. The master controller 124 will decide if that channel needs to be moved to a different state.

The master controller 124 has a 1-packet queue to hold a packet it just extracted from a channel until the kernel requests it. When the controller gives the packet to the kernel, it will consume the master credits and request another packet from a channel of its choosing to fill the 1-packet queue in preparation for the next request from the kernel.

The controller 124 has a configurable master credit utilisation level. When the master credit utilisation exceeds this limit, the controller 124 is signalled to return the channel credits used by all the channels as well as all the master credits used. If there were channels that exceeded their allocated credit utilization in that period, the amount exceeded will be carried over to the next period.

The amount by which the master credit limit was exceeded is calculated and that amount of credits are redistributed evenly to channels which were not able to use up their RT/BW credits in that period.

E.g: We have 3 channels 1, 2, 3
Channel 1: 1000 used credits out of 2000 credits allocated
Channel 2: 1500 used credits out of 1200 credits allocated (exceeded by 300)
Channel 3: 2000 used credits out of 1800 credits allocated (exceeded by 200)
Master credits used: 4500 Master credit limit: 5000

When channel 1 is allowed to send a packet using 1000 credits, it triggers the master credit limit. All channels will have their credits returned to them while those channels which have exceeded their credit utilization will be carried over to the new period. All channels that have not managed to use up their credits will receive credits from channels which have exceeded their credit limit evenly.

Step 1: Triggers the master credit limit
Channel 1: 2000 used credits out of 2000 credits allocated
Channel 2: 1500 used credits out of 1200 credits allocated (exceeded by 300)
Channel 3: 2000 used credits out of 1800 credits allocated (exceeded by 200)
Master credits used: 5500 Master credit limit: 5000
Master credits used exceeded by 500

Step 2: Reset the channel credits and master credit and carry over the exceeded credits
Channel 1: 0 used credits
Channel 2: 300 used credits
Channel 3: 200 used credits
Master credits used: 500 Master credit limit: 5000

Step 3: Distribute the exceeded credits evenly to channels that didn't exceed their credits used.
Channel 1: −500 used credits out of 2000 credits allocated (ie 2500 credits available)
Channel 2: 300 used credits out of 1200 credits allocated (ie 900 credits available)
Channel 3: 200 used credits out of 1800 credits allocated (ie 1600 credits available)
Master credits used: 0 Master credit limit: 5000

In this case only Channel 1 did not exceed its credit limit and the exceeded credits was 300+200=500. So Channel 1 will receive all the exceeded credits since it is the only channel which did not exceed its limit

This credit utilisation process continues for each packet extracted from a channel.

The system scheduler in the master controller 124 uses channel credit utilisation & state information to select a channel to send its packet. The credit levels and utilisation are used to determine a channel's state.

The channel broker will move all newly assigned channels to the IDLE 202 channel scheduler. When a packet arrives for an IDLE channel, the IDLE channel scheduler notifies the channel broker 126 to move the non-idle channel to an appropriate state. The channel will end up in either the RT (204, 128) or BW (203, 127) state depending on whether there is a real-time guarantee placed on the channel. If a channel was GREEDY (205, 129) before it went idle, then it will go to GREEDY (205, 129) again when a new packet arrives.

The credit-based scheduler 125 selects a packet to be sent from a channel in the following order:
Check if there is a RT channel waiting to send from the RT selector 113. If yes, send that packet and forward the channel to the channel broker 126 for dispatching.
Check if there is an BW channel waiting to send from the BW selector 111. If yes, send that packet and forward the channel to the channel broker 126 for dispatching.
Check if there is a GREEDY channel waiting to send from the GREEDY selector 115. If yes, send that packet and forward the channel to the channel broker 126 for dispatching.

The channel broker 126 is informed by a channel that that channel has exceeded its levels. If required, it will give the channel a new state and move the channels to the appropriate channel scheduler of the new state.

The channel broker can perform the state changes from RT (204, 128) to IDLE (202, 131) via 216 or to GREEDY (205, 129) via 211 or to RESTRICTED (206, 130) via 215.

Further possible state changes are from BW (203, 127) to IDLE (202, 131) via 217 or to GREEDY (205, 129) via 210 or to RESTRICTED (206, 130) via 214.

If the RT/BW channel has no more packets to send, it is moved to the IDLE (202, 131) state.

If the RT/BW channel has exceeded their RT/BW credit level, it is moved to the GREEDY (205, 129) state.

If the RT/BW channel has exceeded its rate limiter throughput, it is moved to the RESTRICTED (206, 130) state.

If the GREEDY (205, 129) channel has no more packets to send, it is moved to the IDLE (202, 131) state.

If the GREEDY (205, 129) channel has exceeded the channel rate limiter throughput, it is moved to the RESTRICTED (206, 130) state.

When the master credits have been used and all credits are returned to the channels, channels may move from GREEDY to BW (203, 127) or RT (204, 128).

Channels in the RESTRICTED state (206, 130) cannot send any more packets until they get reassigned by the channel broker (126). These channels are revisited by the channel broker (126) every time quanta to see if any of them can be moved out of the RESTRICTED state (206, 130). Channels can only be move out if their throughput is below their rate limit.

Channels can move from RESTRICTED (206, 130) to RT (204, 128) via 221 or to BW (203, 127) via 220 or to GREEDY (205. 129) via 219.

Once credits are restored in each channel by the master controller (after exceeding the master credit level usage), the channel states are updated to reflect the change of credits.

The main output has a master rate limiter 119 attached to it to control the overall throughput through the kernel. If the main throughput exceeds the throughput limit, then it will not be permitted to send any packets even if the kernel requests for more data. The system may send again once that throughput is below the limit.

Each channel scheduler is in control of one or more channels with the same state. When the credit-based scheduler 125 requests a channel from the channel scheduler, it is up to it to select one channel from the pool of channels under its control based on a certain selection algorithm. Each channel scheduler has a different algorithm for selection.

The RT scheduler 113 algorithm is based on the method for realtime network traffic admission and scheduling.

The BW scheduler 127 algorithm is as follows:
When a channel is moved into BW, it is pushed to the back of the BW channel queue.
The first channel selected to send data is always the channel at the front of the BW queue.
Selected channels at the front of BW queues are pushed to the back of the BW channel queue once data has been transferred to the master controller.

The GREEDY scheduler 115 algorithm is as follows:
The priority can be negative or positive but the higher the value, the more priority the channel gets to be able to transmit. The channel is then inserted into the GREEDY channel queue in descending priority order.
The first channel selected to send is always the channel at the front of the GREEDY queue.

RESTRICTED (206, 130) and IDLE (202, 131) do not have a channel scheduler since they are not chosen to send any packets.

Further embodiments (not illustrated) use types of credits in addition to BW/RT credits and GREEDY credits, to provide additional differentiated levels of service by introducing extra states into the algorithm state machine.

1. A packet switching arrangement including at least two incoming channels and one outgoing channel wherein there is a first means for storing a credit value for each incoming channel, second means for storing a master value, third means adapted to effect a selection of one incoming channel to be permitted to transmit a packet through the outgoing channel, fourth means adapted to effect, upon a transmission from one of the incoming channels to the outgoing channel being permitted, a change in the credit value for that channel and a corresponding change in the master value.

2. A packet switching arrangement as in claim 1 further characterized in that the change in each of the values shall be equal.

3. A packet switching arrangement as in claim 2 further characterized in that each incoming channel has allocated to it a first selected value limit and said third means is further characterised in that it is adapted such that it will not select a given incoming channel while that channel has a value varying from its initial state by more than the magnitude of said first value limit for said channel and while there is at least one other incoming channel with a value varying from its initial state by less than the magnitude of said other channel's first value limit, and where said other channel also has at least one packet to transmit.

4. A packet switching arrangement as in claim 3 further characterized in that the master value has allocated to it a second selected value limit, said fourth means is further characterised in that it is adapted such that when the master value has a value varying from its initial state by more than the magnitude of said second value limit, each channel value and the master value are reset to their initial value.

5. A packet switching arrangement as in claim 4 further characterised in that when each channel value is reset, any magnitude of the channel value immediately prior to the reset, greater than the first value limit for that channel, is offset against the initial value for the channel value for that channel.

6. A packet switching arrangement as in claim 5 further characterised in that when the master value is reset, any magnitude of the master value immediately prior to the reset, greater than the second value limit, is distributed to enhance the channel value of such channels as did not vary the channel value from its initial state by more than the first value limit for that channel.

7. A packet switching arrangement as in claim 6 further characterized in that there are means to characterise an incoming channel as having a selected transmission requirement and said third means is further characterised in that said transmission requirements are satisfied.

8. A packet switching arrangement as in claim 7 further characterized in that the transmission requirement is a maximum inter-packet delay.

9. A packet switching arrangement as in claim 7 further characterised in that the transmission requirement is a fixed inter-packet delay.

10. A packet switching arrangement as in claim 7 further characterised in that the transmission requirement is a minimum bandwidth.

11. A packet switching arrangement as in claim 7 further characterised in that the transmission requirement is a maximum bandwidth.

12. A packet switching arrangement as in claim 1 further characterised in that the value kept for each channel and the master value are such that each channel is constrained within a minimum bandwidth, a maximum bandwidth, and a defined inter-packet delay range.

13. A packet switching arrangement as in claim 7 further characterised in that the third means includes further means to allocate to each incoming channel a state identifier, such identifier being initially selected based on the transmission requirements for that channel and being varied according to the subsequent behaviour of the channel.

14. A packet switching arrangement as in claim 13 in which the state identifier may take a value to indicate that a channel has inter-packet delay requirements.

15. A packet switching arrangement as in claim 13 in which the state identifier may take a value to indicate that a channel has minimum bandwidth requirements.

16. A packet switching arrangement as in claim 13 in which the state identifier may take a value to indicate that a channel has exceeded its minimum transmission requirements.

17. A packet switching arrangement as in claim 13 in which the state identifier may take a value to indicate that a channel has exceeded its maximum bandwidth restriction.

18. A packet switching arrangement as in claim 13 in which the state identifier may take a value to indicate that a channel has no packets to send.

19. A packet switching arrangement as in claim 13 in which the third means is further characterised in that the selection of a channel is based on the state identifier and further means are provided to update the state identifier of the selected channel if the transmission of the packet makes the channel eligible for a different value of the state identifier.

20. A packet switching arrangement as in claim 1 further characterised in that there are means to store a second channel value for each channel and incoming channels are given access to bandwidth on the outgoing channel which is greater than that required to meet the transmission requirement of all of the channels in proportion to the value of the second channel value offset by the value of the first channel value.

21. A method in a packet switching system for arbitrating access for at least two incoming channels to one outgoing channel such that each channel is constrained within a minimum bandwidth, a maximum bandwidth, and a defined inter-packet delay range, including the steps of storing a channel value for each channel, storing a master value, selecting one incoming channel to be permitted to transmit a packet through the outgoing channel, upon a transmission from one of the incoming channels to the outgoing channel being permitted, changing the credit value for that channel and making a corresponding change in the master value.

22. A method as in claim 21 further characterised by including the steps of allocating to each incoming channel a first selected value limit and not selecting a given incoming channel to be permitted to transmit a packet through the outgoing channel while that channel has a channel value varying from its initial state by more than the magnitude of said first value limit for said channel while there is at least one other incoming channel with a value varying from its initial state by less than the magnitude of said other channel's first value limit, where said other channel also has at least one packet to transmit.

23. A method as in claim 21 further characterised by including the steps of allocating a second selected value limit, when the master value has a value varying from its initial state by more than the magnitude of said second value limit, resetting each channel value and the master value are to their initial value, offsetting any magnitude of the channel value immediately prior to the reset, greater than the first value limit for that channel, against the initial value for the channel value for that channel, distributing any magnitude of the master value immediately prior to the reset, greater than the second value limit, to enhance the channel value of such channels as did not vary the channel value from its initial state by more than the first value limit for that channel.
